(19) United States
(12) Patent Application Publication
(10) Pub. No.: US 2012/0296951 A1
(43) Pub. Date: Nov. 22, 2012

(54) SYSTEM AND METHOD TO EXECUTE STEPS OF AN APPLICATION FUNCTION ASYNCHRONOUSLY

(75) Inventor: David Neil Roberts, Leander, TX (US)

(73) Assignee: The Dun and Bradstreet Corporation, Short Hills, NJ (US)

(21) Appl. No.: 13/365,553

(22) Filed: Feb. 3, 2012

Related U.S. Application Data
(60) Provisional application No. 61/439,725, filed on Feb. 4, 2011.

(51) Int. Cl. G06F 15/16

(52) U.S. Cl. 709/201

(57) ABSTRACT

There is provided a method that includes (a) receiving a first request message and a second request message, (b) instantiating a first message handler and instantiating a second message handler, and (c) concurrently processing (i) the first request message via the first message handler to yield a first response message, and (ii) the second request message via the second message handler to yield a second response message. There is also provided a system that employs the method, and a storage medium that contains instructions that cause a processor to perform the method.

### CROSS-REFERENCED APPLICATION

This application claims priority to U.S. Provisional Application No. 61/439,725, filed on Feb. 4, 2011, which is incorporated herein by reference in its entirety.

### BACKGROUND

1. Field of the Invention

The present disclosure relates to executing functions of an application in a computer system. Particularly, the present disclosure relates to a system and method for asynchronous, or concurrent, execution of functions.

2. Description of the Related Art

A conventional program requires that steps in an application be completed serially or in a synchronous fashion. For example, if a program has steps A through C, step A would complete prior to step B, and step B would complete prior to step C. In this fashion a typical program contains instructions that executes steps in order and waits for a completion of a step before executing a subsequent step. A disadvantage with such a program is that the program requires serial processing. This can lead to poor performance indicated by slow execution times.

In particular, the conventional approach is pervasive in web-based applications. Steps in a web-based application may be referred to as messages. A message is a vehicle through which a web-based application requests and delivers information, interactively, to a customer. A message may be a request for information a set of resultant data of such a request, or an instruction for a processor to write data to a data location or to create a file.

A typical web-based application is hosted by a server, e.g., an interactive website. A user accesses the web-based application via an access device, e.g. a computational device with Internet access, and clicks an interactive portion of a webpage, thereby generating a message or request for further data. Typically, the message or request is initially in hyper-text transfer protocol (HTTP) and subsequently converted to an application-specific message. Each interaction can generate a plurality of messages.

The messages are then processed by a processor. The processor processes the message and searches for an appropriate message response, e.g., providing information or performing a requested operation. The processor may search a local database on the server hosting the application, or alternatively, the processor may access a remote database located on a different server. Processing a message typically results in a response message containing requested information data. The response message is then accessed by the application directly, or alternatively, the response message may be stored in a memory location that the application can access and read. The application then displays the response to the user.

According to conventional software principles discussed above, an application can generate multiple messages such as message A, message B, and message C. The application typically generates a request message A, and processes message A with a processor to obtain an appropriate resultant response message A. Response message A is then sent to the application that generated request message A. Typically, the processor will process message A, process message B and process message C before the resultant response messages are sent to the application.

FIG. 1 is a graph 100 of a request time and response time of a prior art system. Graph 100 shows a request message A 105, a request message B 110, a request message C 115, a request message D 120, and a request message E 125. A timeline in seconds is also provided. In operation, request message A 105 through request message E 125 are generated by an application (not pictured). A request queue (not pictured) receives and stores request message A 105 through request message E 125. A processor (not shown) accesses the request queue and processes request message A 105 first, then processes request message B 110, and so on, until the processor processes request message E 125. Then the processor generates a response message 130. Response message 130 represents the compilation of response messages resulting from processing to each of request messages A 105 through E 125 individually. For example, when request message A is processed, information or data associated with the request message A is matched and results in a response message A. Each request message is associated with a resultant response message. Response message 130 is then sent to an application that generated the initial request message A 105 through request message E 125. As demonstrated by the timeline, each of request messages A 105 through E 125 are processed serially. Thus, the total time for the request messages to be processed is a compilation of the amount of time each individual request message takes to be processed. Attempts have been made to increase processor speed; however, ultimately, increases in processor speed do not address the limitation of processing each message before processing a subsequent message.

Due to these deficiencies, a need remains for a system and method of asynchronous processing.

### SUMMARY

There is provided a method that includes (a) receiving a first request message and a second request message, (b) instantiating a first message handler and instantiating a second message handler, and (c) concurrently processing (i) the first request message via the first message handler to yield a first response message, and (ii) the second request message via the second message handler to yield a second response message. There is also provided a system that employs the method, and a storage medium that contains instructions that cause a processor to perform the method.

In one embodiment of the present invention, there is provided a method for asynchronous processing a plurality of steps comprising receiving a plurality of request messages via a request queue; assigning a message handler to each request message; processing each of the request messages resulting in a response message corresponding to each of the request messages; transmitting the response messages to a response queue; and storing the response messages on the response queue. In preferred embodiments of the inventive method, the method also provides that the request messages are generated by an application and transmitted by a dispatcher associated with the application to the request queue. Still further, the request messages are preferably generated by a plurality of applications and transmitted by a plurality of dispatchers associated with the applications to the request queue. And still further, most preferably, the request messages are generated simultaneously.

In another embodiment of the present invention, there is provided system for asynchronous processing a plurality of steps comprising a request queue that stores a plurality of request messages; a message handler pool that assigns a non-allocated message handler to process each of the request messages resulting in a response message corresponding to each of the request messages; and response queue that stores the response messages. Preferably, in the system, there is included an application for generating the plurality of request messages and a dispatcher associated with the application for transmitting the plurality of request messages to the request queue.

In a further embodiment of the present invention, there is provided a storage medium comprising instructions that are readable by a processor and cause the processor to receive a plurality of request messages via a request queue; assign a message handler to each of the request messages; process each of the request messages, resulting in a response message corresponding to each of the request messages; transmit the response messages to a response queue; and store the response messages on the response queue.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a graph of a request time and response time of a prior art system.

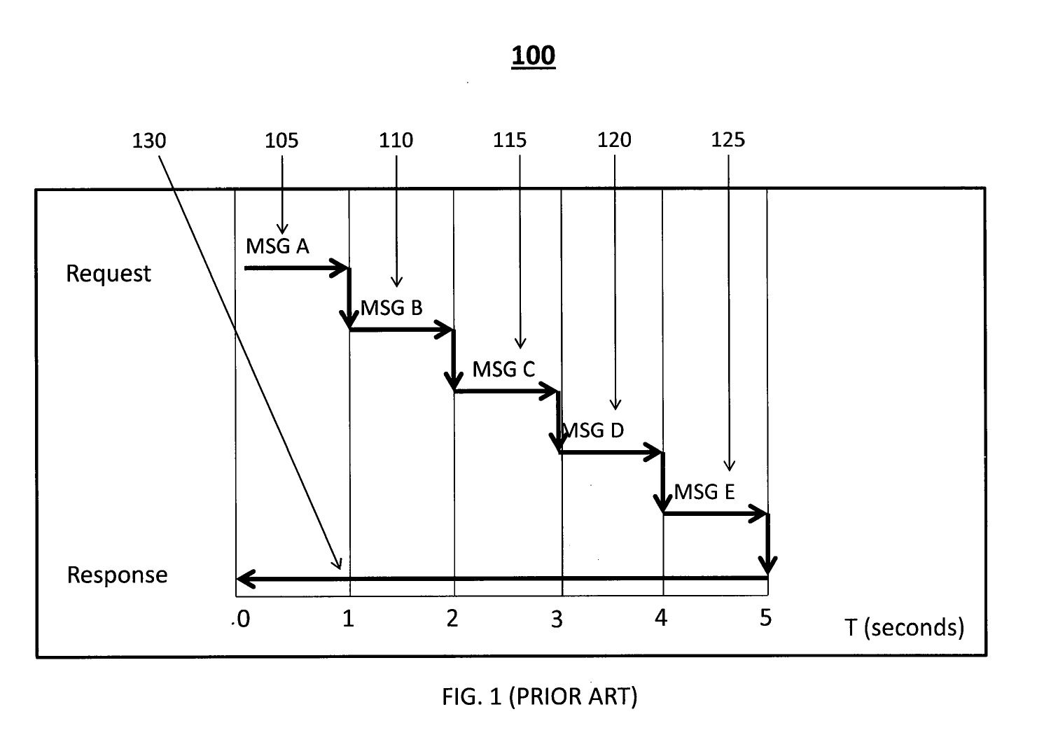

FIG. 2 is a graph of a response time of a system that utilizes asynchronous processing.

FIG. 3 is a block diagram of a system for asynchronous processing according to the present disclosure.

FIG. 4 illustrates a block diagram of a system for asynchronous processing with two applications.

FIG. 5 is a flow chart of process for dispatching a message.

FIG. 6 is a flow chart of process for processing or executing a message.

FIG. 7 is a flowchart of process for receiving a message.

FIG. 8 is a block diagram of another system for asynchronous processing.

FIG. 9 is a block diagram of a system for employment of the present invention.

### DESCRIPTION OF THE PREFERRED EMBODIMENT

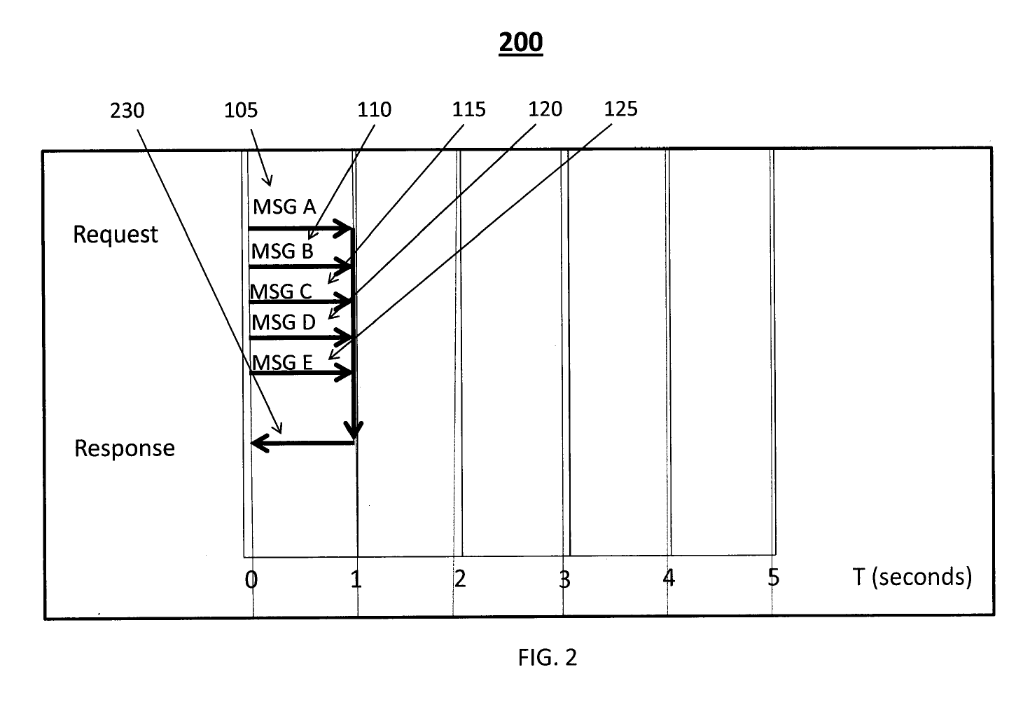

FIG. 2 is a graph 200 of a response time of a system that utilizes asynchronous processing. Graph 200 shows messages A-E, 105-125, which are the same messages as in graph 100. A time (T) in seconds represents horizontal axis of time starting at T=0 and ending at T=5. In this example, messages A-E, 105-125, are processed individually. This may be accomplished by processing each message asynchronously. A response message 230 is also illustrated. Response message 230 is generated at the completion of processing each of messages A-E, 105-125. The asynchronous processing of each message illustrated in graph 200 results in completion of processing at approximately the same time. Response message 230 is generated at the completion of processing of all messages A-E, 105-125 and occurs in a shorter time period as compared to serial processing of graph 100.

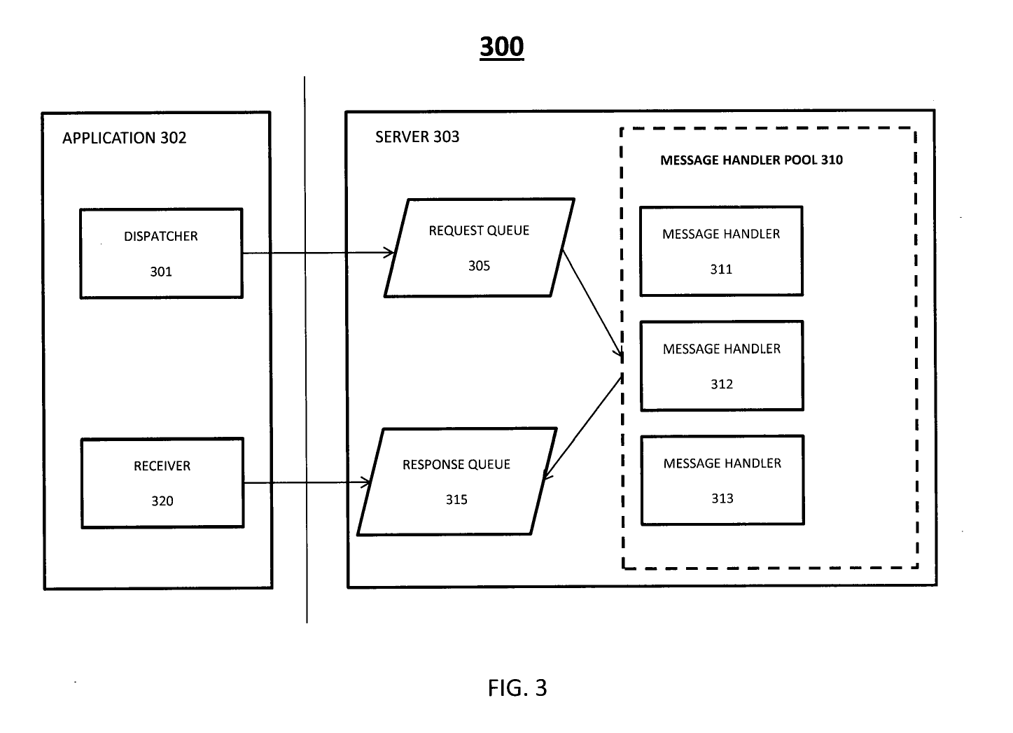

FIG. 3 is a block diagram of a system 300 for concurrent or asynchronous processing. In particular, system 300 provides an application 302 and a server 303. Application 302 includes, but is not limited to: a dispatcher 301 and a receiver 320. Server 303 includes, but is not limited to: a request queue 305, a message handler pool 310 and a response queue 315. Message handler pool 310, may include, but is not limited to: message handlers 311, 312 and 313.

In operation, application 302 generates a message. Application 302 then delivers the message to dispatcher 301. Dispatcher 301 transmits the message to server 303. Server 303, via request queue 305, receives the message. Message handler pool 310 assigns a non-allocated message handler, e.g., message handler 311, to read and process the message from request queue 305 resulting in a response message. Message handler 311 transmits the response message to response queue 315. Receiver 320 of application 302 reads the response message off response queue 315.

System 300 can concurrently handle more than one message. For example, assume that application 302 creates a message A, a message B and a message C. Application 302 then delivers messages A-C to dispatcher 301. Dispatcher 301 dispatches or writes the messages A-C to request queue 305. Request queue 305 is a storage queue that stores each message.

Message handler pool 310 assigns non-allocated message handlers to each stored message on request queue 305. System 300 illustrates three message handlers 311, 312 and 313. Message handler 311 may be assigned to process message A, message handler 312 may be assigned to process message B and message handler 313 may be assigned to process message C. In this fashion, messages in request queue 305 are processed in an asynchronous fashion. Message handler pool 310 instantiates message handlers 311, 312 and 313. That is, message handler pool 310 creates an instance of a message handler according to the number of request messages in request queue 305. Message handler pool 310 may have a configurable limit as to the number of message handlers that can be instantiated.

Processing a message is defined as executing message instructions to return information that the message requested, or alternatively, executing message instructions to write data to a particular data location. Completion of processing of message A results in a message response A that is transmitted from message handler 311 to response queue 315. Similarly, completion of processing of message B results in a message response B that is transmitted from message handler 312 to response queue 315. Likewise, completion of processing message C results in a message response C that is transmitted from message handler 313 to response queue 315. Response queue 315 is a data queue that stores each response message. Receiver 320 reads the response messages in response queue 315 and communicates the response message to the application that generated the initial message.

In preferred embodiments message handlers 311, 312 and 313 transmit a response message to response queue 315 before processing a subsequent message from request queue 305.

Additionally, an index or an address for each message is provided. The index contains identifying information for each message. The index is associated with a request message and also associated with a resultant response message. In this fashion, with reference to the above example with messages A, B and C, message handlers 311, 312 and 313 can process and transmit resultant response messages in any order of completion. Application 302 can identify the resultant response message with the request message by the index. That is, the index allows matching of a response message to the request message. For example, a new message can be created with a name field set on the message, e.g., keyName. The name field matches the request message to the response message. In particular, the name field identifies how the response message will be retrieved from a result map.

For example, the keyName may be created as follows:
//create message
GetTimeMessage getTimeMessage=new GetTimeMessage( );
getTimeMessage.setKeyName(“time”);
MessageDispatcher.dispatch(uuid, getTimeMessage);
Int MessageCount=1;
Map responses=MessageReceiver.receive(uuid, 1);
Long current Time=(Long)responses.get(“time”);

In other embodiments, request queue 305 holds a greater number of messages than message handlers in message handler pool 310. In such embodiments, each message handler 311, 312 and 313 is assigned a message in request queue 305. Message handlers 311, 312 and 313 process the assigned messages and return the appropriate responses to response queue 315 and subsequently become non-allocated. Accordingly, message handler pool 310 assigns any non-allocated message handler to another message in request queue 305. This sequence continues until all messages in request queue 305 are processed.

In further embodiments, system 300 can handle errors, or exceptions. For example, message handlers 311, 312 and 313 process a message that requests information from a database, however, the database is inaccessible, inoperable or corrupted. Accordingly, message handlers 311, 312 and 313 cannot return the requested information but instead return an error. The error is transmitted to response queue 315. Receiver 320 reads the error and relays it to application 302, i.e., throw an exception. In preferred embodiments, if a message handler, alone or in combination with other message handlers, returns an error, no response message will be read by receiver 320. That is, if message handler 311 returns an error, but message handler 312 and/or message handler 313 return a resultant response message, receiver 320 will throw an exception to application 302 and not return any resultant response messages. An error may be read by receiver 320 after all the messages are processed by message handler pool 310, or alternatively, an error may be read by receiver 320 from response queue 315 immediately after the error occurs.

Additionally, in some embodiments, receiver 320 can throw an error due to a time out. Receiver 320 can have a timer that counts an amount of time. Receiver 320 may return a timeout message to application 302 if all resultant response messages are not received in a configurable amount of time. Preferably this time is measured by milliseconds.

Further, in other embodiments, system 300 includes a time-to-live that determines if a message is valid or invalid. The message may be relevant for a finite period of time. After the finite period of time expires the message may lose value. Accordingly, the time-to-live may invalidate a message after expiration of the finite time. The message is not further processed if the message is rendered invalid. The time-to-live may be specified in the request message by dispatcher 301 or, alternatively the time-to-live may be specified by a message handler of message handler pool 310, e.g., message handlers 311, 312 and 313. For example, dispatcher 301 may be configured to transmit a request message to request queue 305 with a time-to-live of 5 seconds. If the message handler pool 310 cannot instantiate a message handler to process the request message within 5 seconds the message is invalidated, e.g., the message is deleted from the request queue 305. In this fashion, system 300 does not process a request message that has a value related to the time-to-live.

Further, in additional embodiments, system 300 includes a data log that captures the execution time of each message. The data log may be configurable to log the time a message remains in dispatcher 301, request queue 305, message handler pool 310, response queue 315 and receiver 320. The data log is an important resource to detect bottlenecks in message flow. In addition message handler pool 310 may log the time it takes message handler 311, 312 or 313 to process a request message. This is particularly useful to detect a bottleneck for a particular processing of a message.

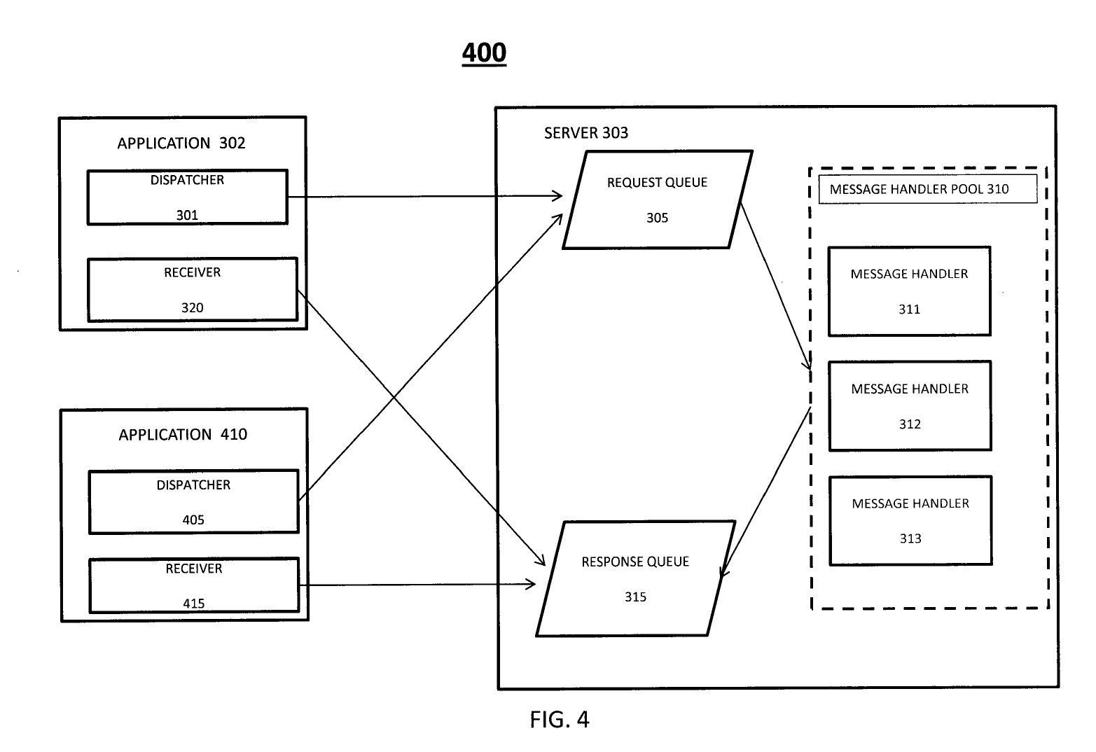

FIG. 4 is a block diagram of an alternative system 400 for concurrent or asynchronous processing. System 400 incorporates asynchronous processing for two applications, i.e., application 302 and an application 410. System 400 incorporates elements from system 300. Specifically, system 400 incorporates application 302 and server 303. Application 302 includes dispatcher 301 and receiver 320. Server 303 includes request queue 305, message handler pool 310 and response queue 315. Additionally, message handler pool 310 includes message handlers 311, 312 and 313. System 400 also includes application 410 having a dispatcher 405 and a receiver 415. Dispatcher 405 and receiver 415 are analogs to dispatcher 301 and receiver 320, respectively.

In operation, request queue 305 receives messages from dispatcher 301 and dispatcher 405. Message handler pool 310, assigns non-allocated message handlers, i.e., message handlers 311, 312 and 313, to read and process messages in request cue 305. The result of processing of a message from request queue 305 is a response message. Message handlers 311, 312 and 313 transmit response messages to response queue 315. Receiver 320 of application 302 reads the response messages off response queue 315 and, likewise, receiver 415 of application 410 reads the response messages off response queue 315. Preferably, a message index or a name field, e.g., a KeyName, is associated with each request message and matched to each response message. Thus, application 302 will read response messages that have an index matching a generated request message from application 302, and application 410 will read response messages that have an index matching a generated request message from application 410. System 400, as shown, illustrates two applications with a common server 303. However, any desired number of applications may be present.

In addition, multiple users may access the same application at the same time. For example, application 302 may be the same as application 410, but represent two different users, i.e., two users accessing the same application from different access devices. If two users access the same application, i.e., application 302 and application 410 are the same, each application 302 and application 410 may be considered different application instances. A universal unique ID (UUID) is used to distinguish messages from different application instances that may be represented by application 302 and application 410. In particular, application 302 generates and attaches a UUID to application 302 messages different from a UUID that application 402 generates and attaches to application 410 messages. The UUIDs from application 302 and application 410 are also sent to receiver 320 and receiver 415. Receiver 320 will use the UUID from application 302 to read application 302 response messages while receiver 415 will use the UUID from application 410 to read application 410 response messages. In this fashion, instances of an application correctly direct response messages to an appropriate instance. Alternatively, different applications may also use the UUID to read messages associated with the respective application off response queue 315.

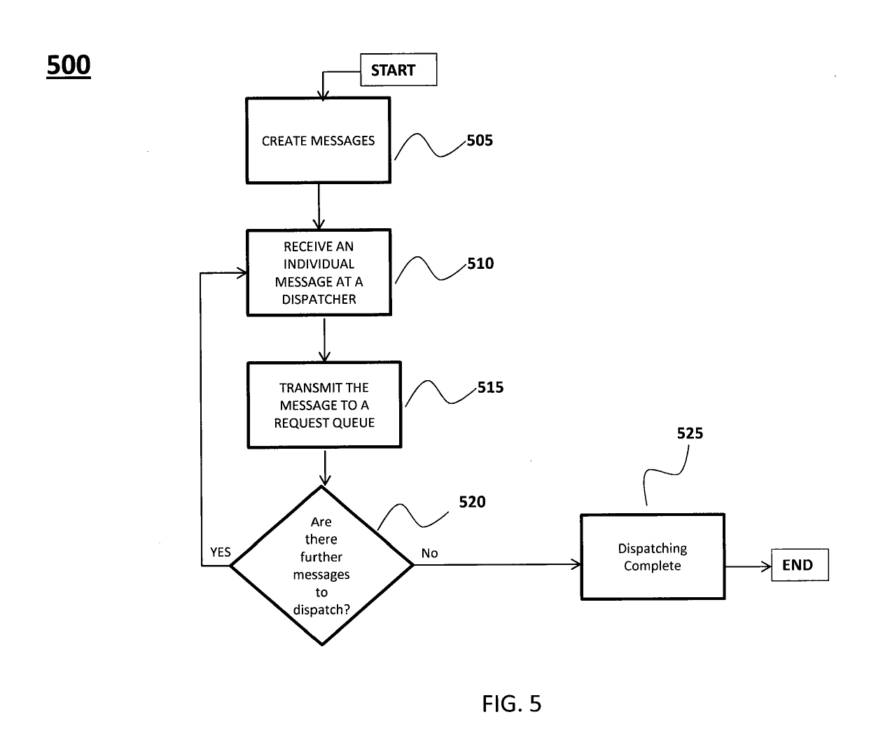

FIG. 5 is a flow chart of a process 500 for dispatching a message.

In step 505 messages are created. Preferably, the messages are created by an application (not shown). Further, each message may be created independent of any other messages.

In step 510, an individual message of the messages is received at a dispatcher.

In step 515, the dispatcher transmits or writes the individual message to a request queue.

In step 520 a decision is made to determine if further messages need to be dispatched. If further messages need to be dispatched, then process 500 loops back to step 510. If no further messages need to be dispatched, then process 500 progresses to step 525.

In step 525 dispatching of messages is completed.

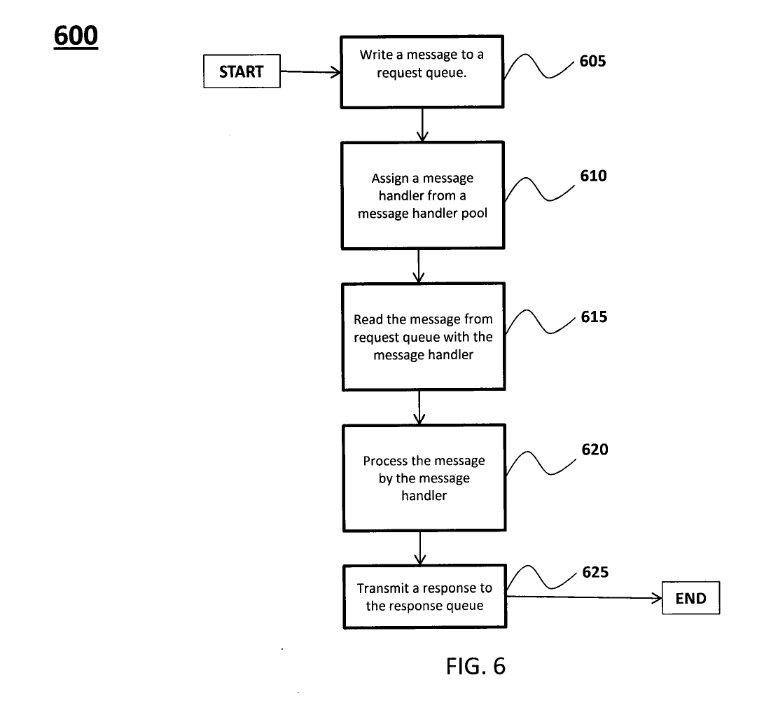

FIG. 6 is a flow chart of a process 600 for processing or executing a message. Process 600 relates to process 500 of FIG. 5. A message written to the request queue in step 515 of process 500 is subsequently followed by step 605 of process 600.

Step 605 starts with a message written to the request queue.

In step 610, a non-allocated message handler is assigned from a message handler pool for each message in the response queue.

In step 615, the message handler reads the message from the request queue.

In step 620, the message handler processes the message. The message handler processes the message and, depending on the message, will search a database for information or, alternatively, the message handler will write data to a data location. Further, processing a message may result in an error if, for example, a message requests data from a database that is inaccessible, inoperable, or does not exist. The message handler will return an error message indicating a processing error. The error may be a general error, or alternatively, the error may specifically indicate why processing of the message could not be completed. Preferably, the message has an index key that is attached to the message and any response message that results from processing step 620.

In step 625, the message handler transmits or writes a response message to a response queue. For example, if a message requests information, the message handler will process the message request and return the information requested.

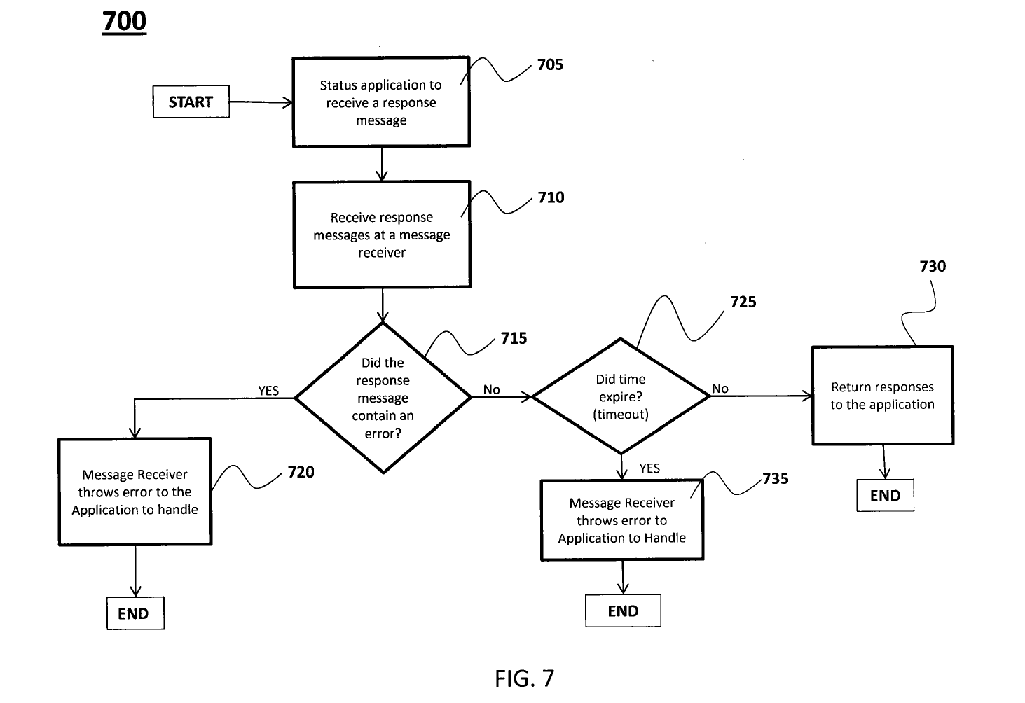

FIG. 7 is a flowchart of a process 700 for receiving a message. Process 700 begins with step 705 to status an application to receive a response message.

In step 710, a message receiver is receiving the response messages. Typically, an application will delegate receiving response messages to a receiver. The receiver reads or receives the response messages from a response queue similar to a response queue provided in step 625.

In step 715, a determination is made as to whether the response message contains an error. The determination in step 715 may be tied to the processing in step 620. That is, if processing the request message results in an error, the message handler will return an error message indicating a processing error. If an error is present, process 700 progresses from step 715 to step 720. If an error is not present, process 700 progresses from step 715 to step 725.

Step 720 provides that the receiver will throw an error to the application to handle. That is, the receiver will relay the error to the application and the application will determine the next action to execute.

Step 725 provides for evaluating if a timeout error occurred. As discussed above in FIG. 3, receiver 320 can throw an error due to a time out. Receiver 320 can have a timer that counts an amount of time, and may return a timeout message to application 302 if all resultant response messages are not received in a configurable amount of time. If a timeout did not occur, process 700 progresses to step 730. If a timeout occurred, process 700 progresses to step 735.

Step 730 provides a return of response messages to an application. The response messages correspond to request messages. In this fashion, an application generates a request message and is returned a response message. The receiver delivers, or returns, all response messages to the application that generated the request messages. The receiver is responsible for aggregating the response messages. The receiver can be configured to throw an error to the application immediately upon occurrence of the error message, or alternatively, the receiver may wait until all the response messages are received before throwing an error.

Step 735, similarly to step 720, throws the error to the application to handle. For example, the error can indicate a timeout occurred.

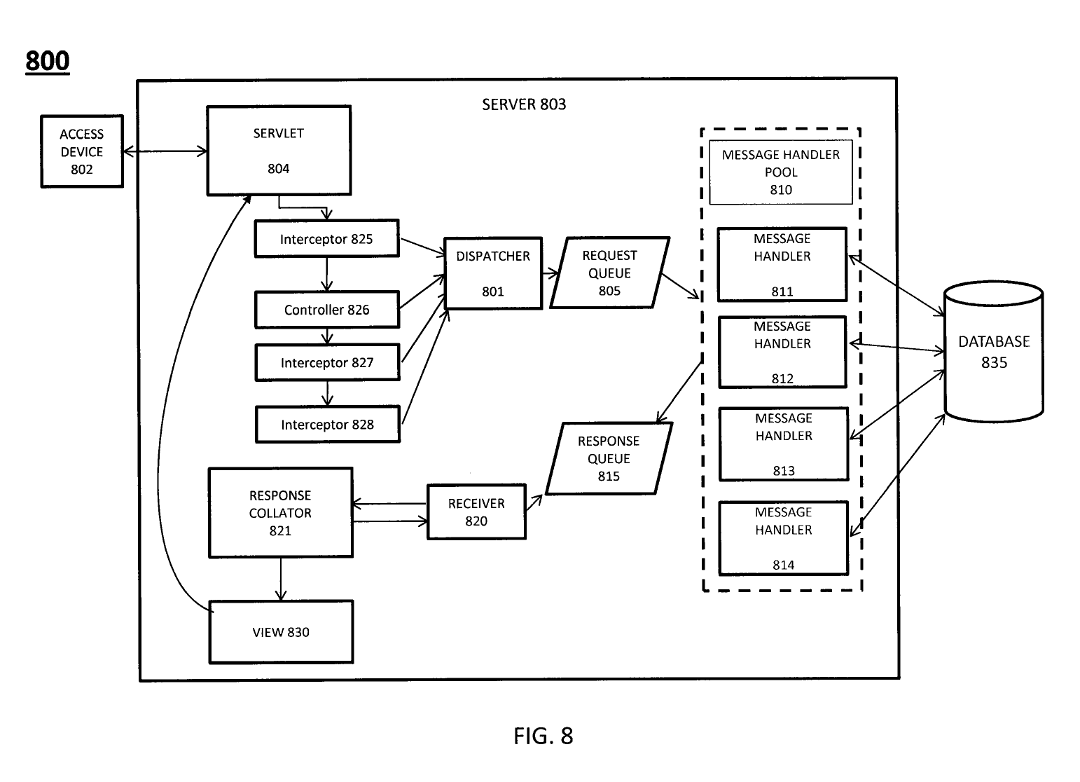

FIG. 8 is another block diagram of a system 800 for asynchronous processing. An access device 802, i.e., a computer terminal, is in communication with server 803. Server 803 may include, but is not limited to: a servlet 804, a dispatcher 801, a request queue 805, a message handler pool 810, a response queue 815, a receiver 820 and a response collator 821. Server 803 further includes interceptors 825, 827 and 828, and a controller 826 disposed between servlet 804 and dispatcher 801. Message handler pool 810 further includes message handlers 811, 812, 813 and 814. Server 803 also includes a view 830 in communication with receiver 820 via a response collator 821. Access device 802, preferably, communicates with server 803, and more particularly servlet 804, via HTTP.

In operation, access device 802 generates messages that are sent to server 803. The messages are typically communicated via HTTP. Servlet 804 receives the messages. Interceptors 825 827 and 828, and controller 826, analyze and identify the messages and generate a request message. The request message is transmitted to dispatcher 801.

For example, interceptor 825 may generate a request message for key financial data, controller 826 may generate a request message for a company overview, interceptor 827 may generate a request message for a company name, and interceptor 828 may generate a request message for a person. Accordingly, a company ID message may be transmitted by access device 802 and sent to servlet 804. Interceptor 825 may be configured to generate a specific key financial request message for the company ID message, and controller 826 may be configured to generate a specific company overview request for the company ID message.

Interceptors 825, 827 and 828 transmit respective request messages to dispatcher 801. If an interceptor does not generate a request, the interceptor will not transmit any request to dispatcher 801. Dispatcher 801 receives the specific request message and transmits the specific request messages to request queue 805.

The request queue 805 is a queue that receives and stores the specific request messages. Message handler pool 810 assigns non-allocated message handlers, i.e., 811, 812, 813 and 184, to each specific request message in request queue 805. Message handlers 811, 812, 813 and 814 process and execute the specific messages. A specific message may include instructions to write data to a data location, or alternatively, the specific request message may request data. Message handler pool 810, and in particular message handlers 811, 812, 813 and 814, are in communication with database 835.

Database 835 contains data that the specific request messages may request, or alternatively, contains data locations to which the specific request messages may write data. Message handlers 811, 812, 813 and 814 process and execute the specific request messages asynchronously or concurrently and transmit, e.g., return, a response message to response queue 815.

Receiver 820 reads the response messages off response queue 815 and transmits the response messages to response collator 821.

Response collator 821 typically begins a request for response messages from receiver 820 subsequent to interceptor 828 generating a request message. Receiver 820 may be configured to wait for all the messages to be processed and read off response queue 815 before transmitting responses to response collator 821. In this fashion, response collator 821 waits for all the response messages. Alternatively, receiver 820 may transmit an error once it occurs. That is, if an error is received in response queue 815, receiver 820 may read the error and relay the error to response collator 821 without waiting for all the responses. Response collator 821 then transmits the response messages to view 830. View 830 interprets the response messages and formats the response messages, resulting in a response view. View 830 transmits the response view to servlet 804. Servlet 804 transmits the response view to access device 802.

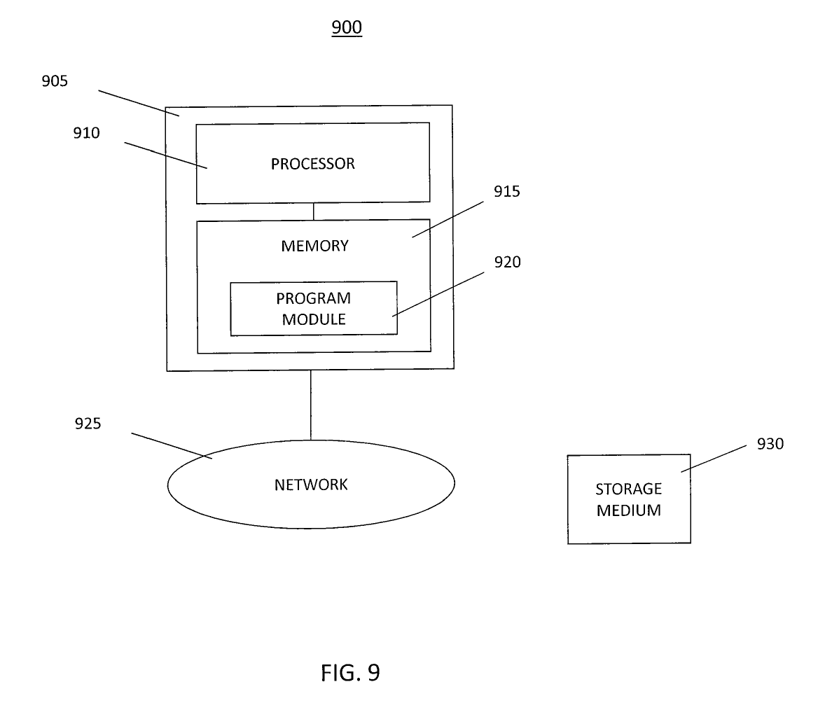

FIG. 9 is a block diagram of a system 900, for employment of the present invention. System 900 includes a computer 905 coupled to a network 925, e.g., the Internet. Computer 905 can, for example, perform operations of application 302, and server 303, application 410, and server 803, and in particular processes 500, 600 and 700.

Computer 905 includes a processor 910, and a memory 915. Although computer 905 is represented herein as a standalone device, it is not limited to such, but instead can be coupled to other devices (not shown) in a distributed processing system.

Processor 910 is an electronic device configured of logic circuitry that responds to and executes instructions.

Memory 915 is a tangible computer-readable storage medium encoded with a computer program. In this regard, memory 915 stores data and instructions that are readable and executable by processor 910 for controlling the operation of processor 910. Memory 915 may be implemented in a random access memory (RAM), a hard drive, a read only memory (ROM), or a combination thereof. One of the components of memory 915 is a program module 920.

Program module 920 contains instructions for controlling processor 910 to execute the methods described herein. For example, program module 920 contains instructions for controlling processor 910 to (a) receive a first request message and a second request message, (b) instantiate a first message handler and instantiate a second message handler, and (c) concurrently process (i) the first request message via the first message handler to yield a first response message, and (ii) the second request message via the second message handler to yield a second response message.

The instructions in program module 920 also cause processor 910 to match the first response message to the first request message, and match the second response message to the second request message.

The instructions in program module 920 also cause processor 910 to attach a first index to each of the first request message and the first response message, and attach a second index to each of the second request message and the second response message. To match the first response message to the first request message, the instructions in program module 920 cause processor 910 to match the first index of the first response message to the first index of the first request message. To match the second response message to the second request message, the instructions in program module 920 cause processor 910 to match the second index of the second response message to the second index of the second request message. Since system 900 processes the first and second request messages concurrently, and asynchronously from one another, the second message handler can complete processing of the second request message to yield the second response message before the first message handler completes processing of the first request message to yield the first response message.

In the present document, although we describe operations being performed by application 302, server 303, application 410, server 803, and processes 500, 600 and 700, the operations can be performed by processor 910.

Processor 910 outputs results, e.g., response messages, via network 925, to an external device, such as access device 802.

While program module 920 is indicated as already loaded into memory 915, it may be configured on a storage medium 930 for subsequent loading into memory 915. Storage medium 930 is a tangible computer-readable storage medium and can be any conventional storage medium that stores program module 920 thereon. Examples of storage medium 930 include a compact disk, a magnetic tape, a read only memory, an optical storage media, a hard drive or a memory unit consisting of multiple parallel hard drives, and a universal serial bus (USB) flash drive. Storage medium 930 can also be a random access memory, or other type of electronic storage, located on a remote storage system and coupled to computer 905 via network 925.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
receiving a first request message and a second request message;
instantiating a first message handler and instantiating a second message handler; and
concurrently processing (i) said first request message via said first message handler to yield a first response message, and (ii) said second request message via said second message handler to yield a second response message.

2. The method of claim 1, further comprising:
matching said first response message to said first request message, and matching said second response message to said second request message.

3. The method of claim 2, further comprising:
attaching a first index to each of said first request message and said first response message; and
attaching a second index to each of said second request message and said second response message;
wherein said matching said first response message to said first request message comprises matching said first index of said first response message to said first index of said first request message; and
wherein said matching said second response message to said second request message comprises matching said second index of said second response message to said second index of said second request message.

4. The method of claim 3, wherein said processing of said second request message is completed before said processing of said first request message.

5. A system comprising:
a processor; and
a memory that contains instructions that when read by said processor, cause said processor to:
receive a first request message and a second request message;
instantiate a first message handler and instantiate a second message handler; and
concurrently process (i) said first request message via said first message handler to yield a first response message, and (ii) said second request message via said second message handler to yield a second response message.

6. The system of claim 5, wherein said instructions further cause said processor to match said first response message to said first request message, and match said second response message to said second request message.

7. The system of claim 6,
wherein said instructions further cause said processor to attach a first index to each of said first request message and said first response message, and attach a second index to each of said second request message and said second response message,
wherein to match said first response message to said first request message, said instructions cause said processor to match said first index of said first response message to said first index of said first request message, and
wherein to match said second response message to said second request message, said instructions cause said processor to match said second index of said second response message to said second index of said second request message.

8. The system of claim 7, wherein said second message handler completes processing of said second request message to yield said second response message before said first message handler completes processing of said first request message to yield said first response message.

9. A storage medium that is tangible and readable by a processor, and comprises instructions that, when read by said processor, cause said processor to:
receive a first request message and a second request message;
instantiate a first message handler and instantiate a second message handler; and
concurrently process (i) said first request message via said first message handler to yield a first response message, and (ii) said second request message via said second message handler to yield a second response message.

10. The storage medium of claim 9, wherein said instructions further cause said processor to match said first response message to said first request message, and match said second response message to said second request message.

11. The storage medium of claim 10,
wherein said instructions further cause said processor to attach a first index to each of said first request message and said first response message, and attach a second index to each of said second request message and said second response message,
wherein to match said first response message to said first request message, said instructions cause said processor to match said first index of said first response message to said first index of said first request message, and
wherein to match said second response message to said second request message, said instructions cause said processor to match said second index of said second response message to said second index of said second request message.

12. The storage medium of claim 11, wherein said second message handler completes processing of said second request message to yield said second response message before said first message handler completes processing of said first request message to yield said first response message.
